(19) United States
(12) Patent Application Publication
(10) Pub. No.: US 2018/0157057 A1
(43) Pub. Date: Jun. 7, 2018

(54) OPTICAL SYSTEM WITH COMPACT COLLIMATING IMAGE PROJECTOR

(71) Applicant: LUMUS LTD., Ness Ziona (IL)

(72) Inventors: Jonathan GELBERG, Modiin (IL); Mordechai GILO, Rehovot (IL); Aviad BAR MEIR, Kiryat-Arba (IL); Aviv FROMMER, Yokneam Moshava (IL)

(21) Appl. No.: 15/879,459

(22) Filed: Jan. 25, 2018

Related U.S. Application Data
(63) Continuation of application No. PCT/IL2017/051309, filed on Dec. 3, 2017.
(60) Provisional application No. 62/429,127, filed on Dec. 2, 2016.

(51) Int. Cl. G02B 27/28; G03B 21/00; G03B 21/20; G02F 1/1362; G02B 27/30

(52) U.S. Cl. CPC G02B 27/283; G03B 21/006; G03B 21/2073; G02F 2203/02; G02F 1/136277; G02B 27/30; G03B 21/2006

(57) ABSTRACT

An optical system (100) includes an image-collimating prism (102) having external surfaces which are associated with: a polarized source; reflective-display device (70); at least one light-wave collimating component (16) and a light-wave exit surface (20), respectively. A polarization-selective beam splitter configuration (10) is deployed within the prism (102) on a plane oblique to the light-wave entrance surface (8). The reflective-display device is illuminated by light reflected from the beam splitter configuration (10), and generates rotation of the polarization corresponding to bright regions of the image. An image from the reflective-display device (70) is selectively transmitted by the polarization-selective beam splitter configuration (10), is collimated by the collimating component (16), reflected from the polarization-selective beam splitter configuration (10) and is projected through the exit surface (20). In some implementations, an additional polarizer located at or near the exit surface helps to optimize extinction of unwanted illumination rays.

### FIELD AND BACKGROUND OF THE INVENTION

The present invention relates to optical systems and, in particular, it concerns an optical system with a compact collimating image projector.

Compact optical devices are particularly needed in the field of head-mounted displays (HMDs), wherein an optical module performs functions of image generation (an “imager”) and collimation of the image to infinity, for delivery to the eye of a viewer. The image can be obtained from a display device, either directly from a spatial light modulator (SLM), such as a cathode ray tube (CRT), a liquid crystal display (LCD), a liquid crystal on silicon (LCoS), a digital micro-mirror device (DMD), an OLED display, a scanning source or similar devices, or indirectly, by means of a relay lens or an optical fiber bundle. The image, made up of an array of pixels, is focused to infinity by a collimating arrangement and transmitted into the eye of the viewer, typically by a reflecting surface or a partially reflecting surface acting as a combiner, for non-see-through applications and see-through applications, respectively. Typically, a conventional, free-space optical module is used for these purposes.

As the desired field-of-view (FOV) of the system increases, conventional optical modules of this type become heavier and bulkier, and hence impractical, even for a moderate performance device. This is a major drawback for all kinds of displays, but especially in head mounted applications, where the system must necessarily be as light and compact as possible.

The quest for compactness has led to several different complex optical solutions, many of which are still not sufficiently compact for most practical applications, and at the same time, suffer drawbacks in terms of cost, complexity and manufacturability. In some cases, the eye-motion-box (EMB) over which the full range of optical viewing angles is visible is small, for example, less than 6 mm, rendering performance of the optical system sensitive to even small movements of the optical system relative to the eye of the viewer, and failing to accommodate sufficient pupil motion for comfortable reading of text from such displays.

A particularly advantageous family of solutions for HMDs and near-eye displays are commercially available from Lumus Ltd. (Israel), typically employing light-guide substrates (waveguides) with partially reflecting surfaces or other applicable optical elements for delivering an image to the eye of a user. Various aspects of the Lumus Ltd. technology are described in the following PCT patent publications, which are hereby incorporated by reference as providing relevant background to the present invention: WO 01/95027, WO 2006/013565, WO 2006/085309, WO 2006/085310, WO 2007/054928, WO 2008/023367 and WO 2008/129539.

### SUMMARY OF THE INVENTION

The present invention is an optical system with a compact collimating image projector. Certain preferred embodiments of the present invention provide a simple and compact solution for wide FOV together with relatively large EMB values. The resulting optical system can be implemented to provide a large, high-quality image, which also accommodates large movements of the eye.

According to the teachings of an embodiment of the present invention there is provided, an optical system, comprising: (a) an image-collimating prism comprising a light-wave transmitting material, the prism having a plurality of external surfaces including a light-wave entrance surface and a light-wave exit surface, an image display surface and a collimation surface, a polarization-selective beam splitter configuration being deployed within the prism on a plane oblique to the light-wave entrance surface; (b) a source of polarized light associated with the light-wave entrance surface; (c) a reflective-display device associated with the image display surface of the prism, the reflective-display device generating spatial modulation of reflected light corresponding to an image, the reflective-display device being illuminated by light from the polarized source reflected from the beam splitter configuration, the reflective-display device being configured such that the reflected light corresponding to bright regions of the image has a polarization rotated relative to the source of polarized light; (d) at least one retardation plate associated with at least part of the collimation surface; and (e) at least one light-wave collimating component overlying at least part of the retardation plate, such that an image from the reflective-display device is selectively transmitted by the polarization-selective beam splitter configuration, is collimated by the collimating component, reflected from the polarization-selective beam splitter configuration and is projected through the exit surface.

According to a further feature of an embodiment of the present invention, the light-wave entrance surface and a light-wave exit surface of the prism are parallel.

According to a further feature of an embodiment of the present invention, at least one angle between adjacent surfaces of the prism is non-orthogonal.

According to a further feature of an embodiment of the present invention, the prism is a cuboid prism, and in one case, a square cuboid prism.

According to a further feature of an embodiment of the present invention, the polarization-selective beam splitter configuration is a wire grid beam splitter.

According to a further feature of an embodiment of the present invention, the polarization-selective beam splitter configuration is a compound beam splitter configuration comprising: (a) a first beam-splitter element closest to the source of polarized light; (b) an absorptive polarizer; and (c) a second beam-splitter element closest to the light-wave collimating component.

According to a further feature of an embodiment of the present invention, the first beam-splitter element is a wire-grid beam splitter element.

According to a further feature of an embodiment of the present invention, there is also provided an exit polarizer associated with the light-wave exit surface of the prism, the exit polarizer being oriented in crossed-relation to the polarization-selective beam splitter configuration so as to ensure extinction of any illumination from the source of polarized light that traverses the polarization-selective beam splitter configuration.

According to a further feature of an embodiment of the present invention, the reflective-display device comprises a liquid-crystal-on-silicon display.

According to a further feature of an embodiment of the present invention, there is also provided a light-guiding substrate having at least two major surfaces parallel to each other, and a light-wave input aperture, wherein the light-wave input aperture is optically coupled to the light-wave exit surface of the prism.

According to a further feature of an embodiment of the present invention, the light-transmitting substrate contains at least one partially-reflective surface extending within the substrate at an oblique angle to the major surfaces.

According to a further feature of an embodiment of the present invention, the at least one retardation plate includes a first retardation plate having a fast axis aligned with an axis of polarization and a second retardation plate having a fast axis aligned at 45 degrees to an axis of polarization.

The term “light-guide” as used herein in the description and claims refers to any light-transmitting body, preferably light-transmitting solid bodies, which may also be referred to as “optical substrates”.

### BRIEF DESCRIPTION OF THE DRAWINGS

The invention is herein described, by way of example only, with reference to the accompanying drawings, wherein:

FIG. 1 is a schematic exploded plan view of an optical system providing a compact collimating image projector, constructed and operative according to an embodiment of the present invention;

FIG. 2 is a schematic exploded plan view of the optical system of FIG. 1 modified by addition of an exit polarizer;

FIG. 3 is a schematic view similar to FIG. 2 illustrating a potential path of unwanted radiation from a light source reaching an output of the image projector;

FIG. 4 is a schematic exploded plan view of the optical system of FIG. 2 further exploded to show details of a preferred implementation of a polarization-selective beam splitter configuration including a plurality of polarizing elements;

FIG. 5 is a schematic view similar to FIG. 4 illustrating a potential path of unwanted radiation from a light source reaching an output of the image projector;

FIG. 6 is a graph showing variation of transmission of an undesirable optical signal as a function of out-of-plane skew-beam angle for various different combinations of polarizing elements;

FIG. 7 is a schematic plan view of the optical system of FIGS. 1, 2 and 4 after assembly of various components into a unitary structure;

FIG. 8 is a schematic plan view of an optical system including the device of FIG. 7 coupled to a light-guide substrate;

FIG. 9 is a schematic plan view of an optical system similar to that of FIG. 7 implemented with non-rectangular geometry; and

FIG. 10 is a graph illustrating a relationship between display contrast ratio of background noise.

### DESCRIPTION OF THE PREFERRED EMBODIMENTS

The present invention is an optical system with a compact collimating projector coupled to a light-guiding substrate.

The principles and operation of optical systems according to the present invention may be better understood with reference to the drawings and the accompanying description.

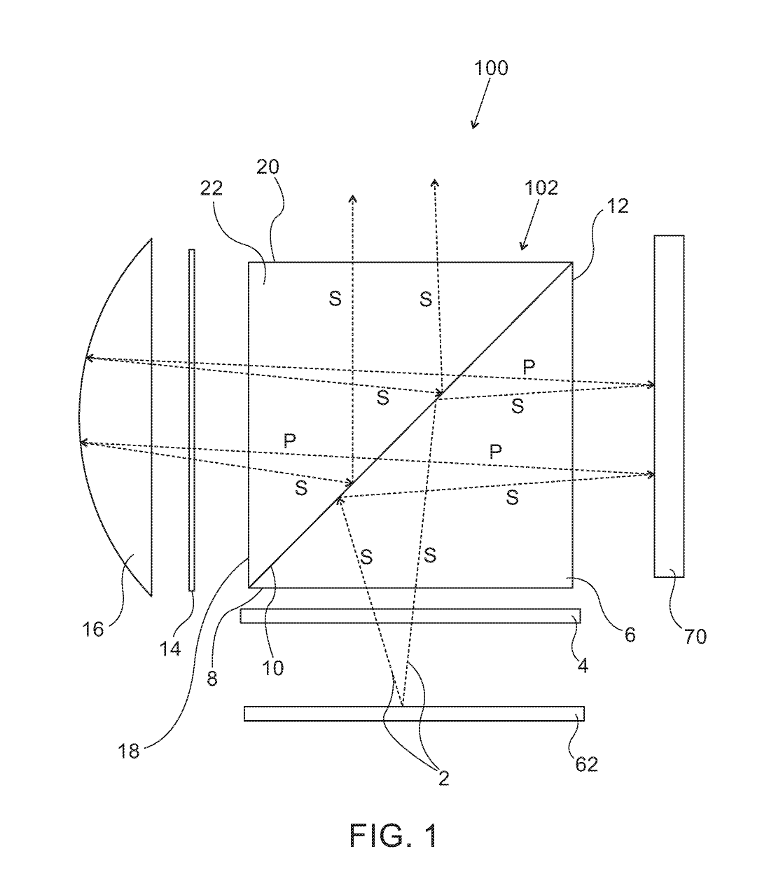

Referring now to the drawings, FIGS. 1, 2, 4 and 7-8 illustrate various implementations of an optical system, generally designated 100, constructed and operative according to various aspects of the present invention. In general terms, system 100 includes an image-collimating prism 102, formed from a light-wave transmitting material, which has a number of external surfaces including a light-wave entrance surface 8, a light-wave exit surface 20, an image display surface 12 and a collimation surface 18. A polarization-selective beam splitter configuration 10 (which may be referred to in short as “PBS 10”) is deployed within prism 102 on a plane oblique to light-wave entrance surface 8.

A source of polarized light, shown here as a combination of a light source 62 with a polarizer 4, is associated with the light-wave entrance surface 8. A reflective-display device associated with the image display surface of the prism, the reflective-display device 70, generating spatial modulation of reflected light corresponding to an image, is associated with image display surface 12. Reflective-display device 70 is illuminated by light from the polarized source reflected from beam splitter configuration 10. Reflective-display device 70 is configured such that the reflected light corresponding to a bright region of a desired image has a polarization rotated relative to the source of polarized light. Thus, as shown in the aforementioned drawings, polarized illumination enters prism 102 through entrance surface 8 with a first polarization, typically an s-polarization relative to beam splitter configuration 10, and is reflected towards image display surface 12 where it impinges on reflective-display device 70. Pixels corresponding to bright regions of the image are reflected with modulated rotated polarization (typically p-polarization) so that radiation from the bright pixels is transmitted through the beam splitter configuration 10 and reaches collimation surface 18 where it passes through at least one retardation plate, preferably a quarter-wave plate 14, associated with at least part of the collimation surface, enters at least one light-wave collimating component 16 overlying at least part of the retardation plate, and is reflected back through quarter-wave plate 14. The double pass through a quarter-wave plate 14 aligned with its fast axis at 45 degrees to the polarization axes rotates the polarization (e.g., transforming the p-polarization to s-polarization) so that the collimated image illumination is reflected at beam splitter configuration 10 towards exit surface 20.

In a particularly preferred but non-limiting set of applications of the present invention, light-wave exit surface 20 of image collimating prism 102 is optically coupled to a light-wave input aperture of a light-guiding substrate 36 having at least two major surfaces 32 and 34 parallel to each other. In this case, an image from reflective-display device 70 illuminated by the light source via reflection in beam splitter configuration 10 is collimated by collimating component 16 and reflected from beam splitter configuration 10 so as to pass through exit surface 20 and into the input aperture of light-guiding substrate 36 so as to propagate within the substrate by internal reflection.

At this stage, it will be appreciated that the present invention provides a particularly advantageous optical system. In particular, by employing a single polarization-selective beam splitter configuration 10 to deliver illumination to reflective-display device 70 and to reflect collimated light from collimating component 16 to exit surface 20, it is possible to achieve a highly compact implementation of collimating prism 102 with particularly short focal length, which may be advantageous for providing a wide FOV display for a given size of reflective-display device, in contrast to prior devices which typically require two separate prism assemblies for these two functions.

One consequence of the compact configuration defined herein is that, in certain implementations, the illumination source is opposite the exit aperture of the prism. This may in some cases require special precautions to ensure that no source illumination leaks through the beam splitter exiting the exit aperture to reach the light-guiding substrate, which could increase noise and reduce image contrast. Various embodiments described below disclose various particularly preferred implementations in which elements are provided to enhance extinction of illumination radiation, even at high “skew beam” angles, from reaching the light-guiding substrate.

Various particularly preferred implementations of the present invention exploit the fact that in some Spatial Light Modulators (SLM) micro-display sources, such as LCDs or LCOS displays, the operation is based on polarized light incident on the device, which is reflected at a different polarization state. Non-polarizing reflecting SLMs, can also be used by adding a quarter wave plate at the entrance to the SLM. This will turn also these types of SLMs to a polarization rotating SLM, suitable for use in the devices of the present invention, as the double path of the light beam through the quarter-wave-plate in the incoming and out-coming paths rotates the light beam polarization.

In the following descriptions, reference will be made to LCOS as an example of a reflecting and polarization rotating micro-display, but it should be noted that this is only a non-limiting example, and other polarization rotating micro-displays, referred to as “reflective-display devices”, are also applicable.

The collimating prism 102 is based on two prisms, labeled 6 and 22 in FIG. 1, where at least one of them is provided on the hypotenuse side with a polarizing beam splitter (PBS) forming at least part of polarization-selective beam splitter configuration 10, which reflects the s-polarization and transmits the p-polarization. The two hypotenuse sides of the prisms are cemented to each other, to form a cemented collimating prism assembly. This single cemented prism is used for illumination of the LCOS and also for collimation of the LCOS.

The geometrical form of cemented prism 102 may vary according to the application, and is not necessarily based on orthogonal surfaces. In certain preferred implementations, light-wave entrance surface 8 and light-wave exit surface 20 of the prism are parallel. In certain particularly preferred implementations, the prism is a cuboid prism, i.e., with rectangular faces orthogonal to each other, and in certain particularly preferred examples illustrated here, it is a square cuboid prism, where each component prism 6 and 22 has a 45 degree right-angled cross-sectional shape. Depending on the details of the particular application, it may be preferable to use non-orthogonal prism surfaces, and polarizing beam-splitter arrangements that are deployed at angles other than 45 degrees. One non-limiting example of a non-rectangular device is show in FIG. 9. Other than changes directly resulting from the variant non-rectangular geometry, the structure and function of the device of FIG. 9 are similar to that of FIG. 1, with analogous elements being labeled similarly.

Incident light beam 2, which can be from an LED, a laser or any other light source 62, passes through a linear polarizer 4, as illustrated in FIG. 1. Linear polarizer 4 is not needed in a case where light-source 62 is itself polarized, although it may still be advantageous to ensure high quality of the polarized illumination. The incident light beam 2 is linearly s-polarized, with regards to the surface of PBS 10, as illustrated in FIG. 1. As shown, the s-polarized input light-waves 2 from the light source are coupled into prism 102 (which can be considered a “light-guide” optical device constructed from prisms 6 and 22 with PBS 10 in between), which is composed of a light-waves transmitting material, through its entrance surface 8. Following reflection from PBS 10, the light-waves are coupled-out of the substrate through an external surface 12 of prism 6. The light-waves are reflected by the LCOS element 70 which converts the s-polarization state to p-polarization for the bright image signal. The p-polarized light-waves re-enter the optical element 6 through surface 12. The now p-polarized light-waves pass through PBS 10, then are coupled out of the light-guide through the external surface 18 of the prism 22. The light-waves then pass through at least one quarter-wavelength retardation plate 14, are reflected by a reflecting and collimating optical element 16, e.g., a spherical collimating mirror, return to pass again through the retardation plates 14, and re-enter the light-guide through external surface 18. Most preferably, two retardation plates are used, with their fast axes at 0° and 45° to the polarization axes, respectively. The double pass through the 45° retardation plate 14 changes the light beam from p-polarization to s-polarization. The 0° retardation plate helps to ensure effective extinction of unwanted high-angle skew rays at polarizing beam splitter 28. The light beam is then reflected by PBS 10 and exits prism 22 through the external surface 20. These light waves contain the image information modulated by the LCOS and collimated by the reflecting optical element 16. In some configurations, this beam will be coupled to an optical combiner element that will reflect it to be viewed by the eye or a camera. Performance of this embodiment is dependent upon PBS 10 being a highly efficient polarizer. Further examples will be shown where this polarizer is less efficient and additional elements are used to achieve high image contrast.

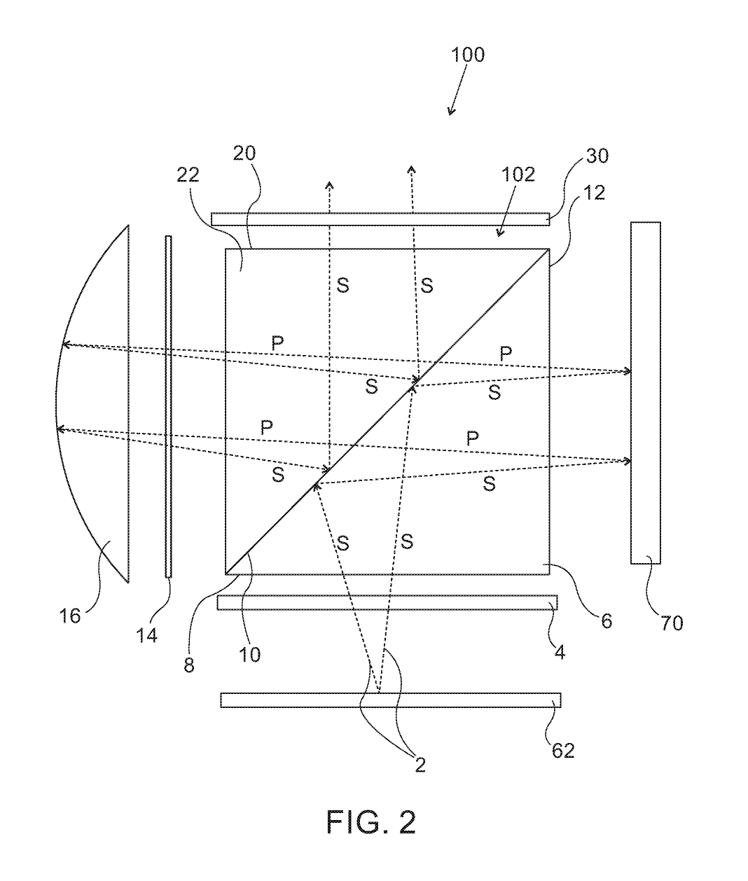

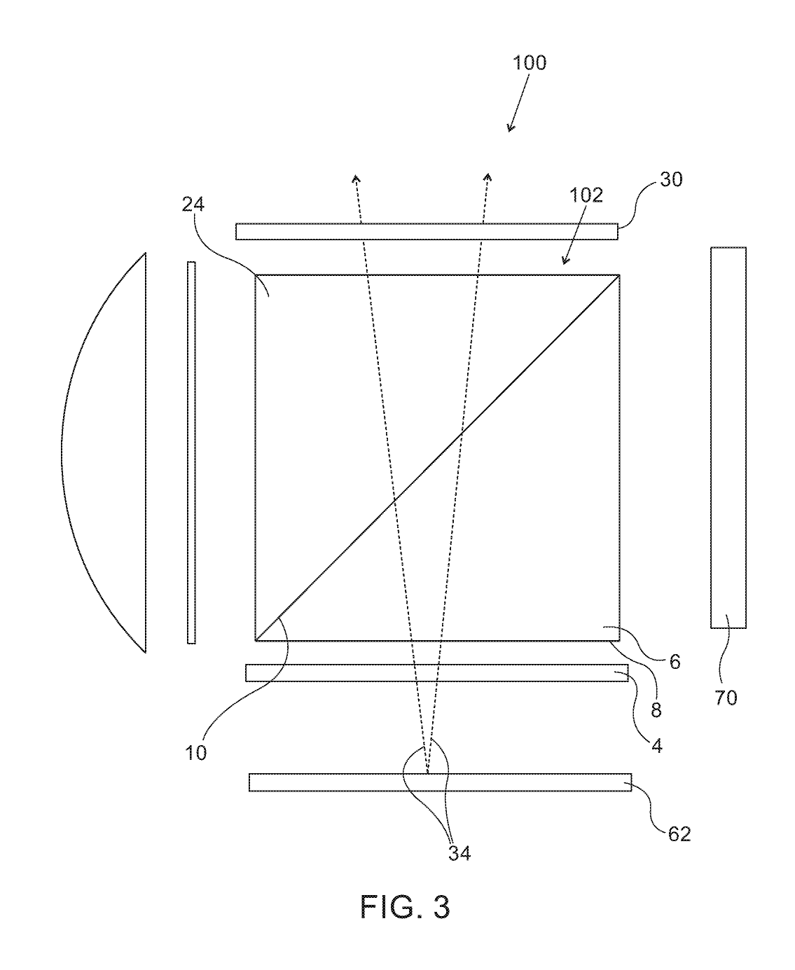

Another embodiment is shown in FIG. 2 where a linear polarizer 30 is added to the light waves exiting surface 20. Polarizer 30 is oriented with its axis of polarization parallel to polarizer 4, in order to pass the s-polarization reflected from PBS 10. The addition of this polarizer helps to extinguish undesired light passing directly from light source 62. An exemplary path of such undesired light is shown in FIG. 3. A beam of light waves 34 is shown as a dashed line. Incident light waves 34 which can be from a LED, a laser or any other light source 62, pass through a linear polarizer 4 (linear polarizer 4 is optional in the case where the light-source itself is polarized) as illustrated in FIG. 3. The light waves are linearly s-polarized in regards to the plane of PBS 10. However, skew rays (out of the plane of the drawing) have some small p-polarization content relative to PBS 10. These light waves enter surface 8, are coupled into prism 102, pass through PBS 10, pass through external surface 20 of prism 22, and reach linear polarizer 30. The undesired p-polarized light is removed by linear polarizer 30, allowing a high contrast ratio of the picture information. For this purpose, the linear polarizer 30 has its polarization axis parallel to that of linear polarizer 4. This configuration is effective if PBS 10 is assumed to approximate well to an ideal wide spectral polarizer. Further examples will be discussed below to address situations where this polarizer is non-ideal. The additional polarizer is also useful in helping to counter the effects of any stress birefringence which may be introduced into the optical path.

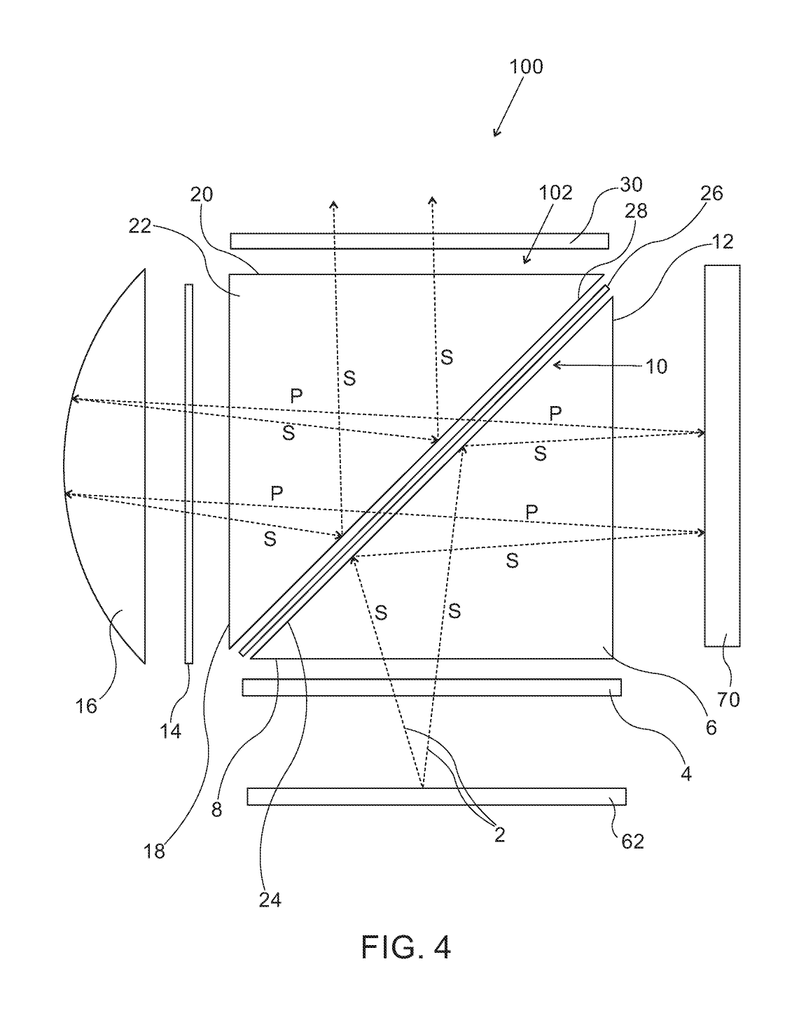

Another embodiment is illustrated in FIG. 4, where the polarization-selective beam splitter configuration 10 is a compound beam splitter configuration which includes a first polarizing beam-splitter element (PBS) 24, closest to the source of polarized light, an absorptive polarizer 26, and a second polarizing beam-splitter element (PBS) 28, closest to the light-wave collimating component 16. The polarizing beam-splitter elements 24 and 28 can be implemented as any sort of polarizing beam-splitter including, but not limited to, polarizing beam-splitters formed from multiple layers of dielectric coatings and wire-grid metallic strips. In one particularly preferred implementation described further below, at least first polarizing beam-splitter element 24 is a wire-grid element.

As before, the optical device is based on two prisms, indicated 6 and 22, each having a PBS on the hypotenuse side 24 and 28 respectively, which reflect the s-polarization and transmit the p-polarization. Although throughout the drawings, various components are illustrated for clarity schematically with spaces between them, the adjacent parallel surfaces are typically cemented together with optical cement to form rigid unitary structures. Thus, in this case, the two hypotenuse sides of the prisms are cemented to each other with a linear polarizer 26 in between, which transmits the p-polarization, whereby this assembly becomes a cemented cube prism. The absorptive polarizer 26 greatly contributes to extinction of the s-polarization that passes through PBS 24 and 28, since in real world applications these PBS are not ideal and do not reflect all of the s-polarization. In particular, where dielectric PBS elements are used for elements 24 and 28, the selective transmission for high-angle skew rays includes a component of s-polarization. These components are removed by the absorptive polarizer 26 which is a Cartesian (fixed axis) polarizer.

As mentioned above, various applications of the present invention may employ prisms with non-rectangular forms. In certain cases, it may be desirable to have a difference in orientation between beam splitter elements 24 and 28. In such a case, an additional wedge (not shown) may be provided between the beam splitter elements to achieve the desired difference in orientation angle.

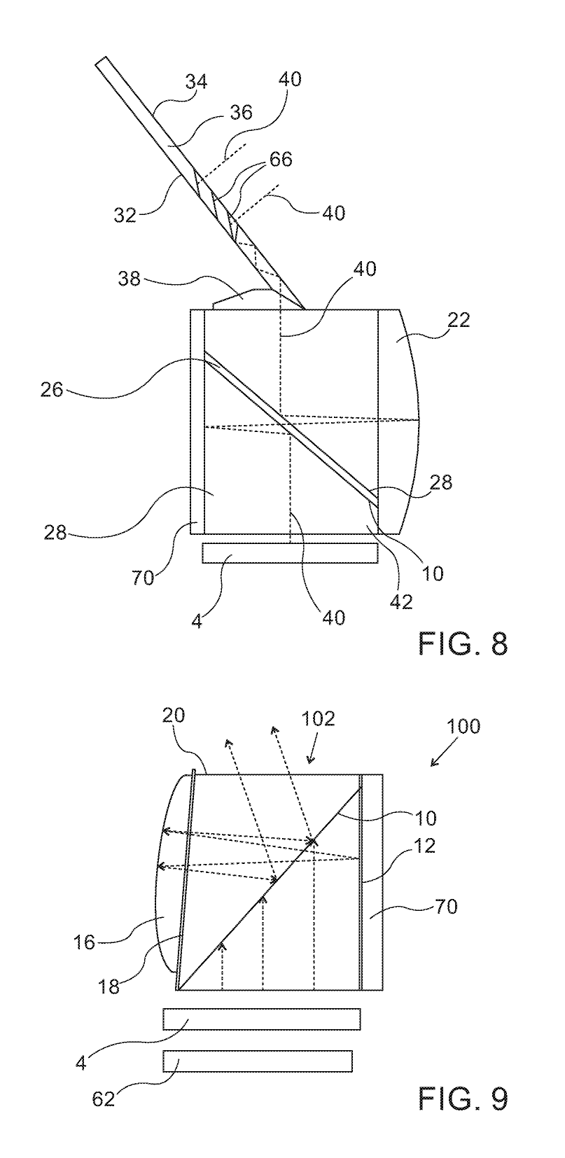

In all other respects, the structure and function of the device of FIG. 4 is equivalent to that described above in the context of FIGS. 1-3, and will be understood by reference to that description. In some particularly preferred but non-limiting application, the output image beam from light-wave exit surface 20 will be coupled, preferably via polarizer 30, to an optical combiner element that will reflect it to be viewed by the eye or a camera, as discussed further with reference to FIG. 8, below.

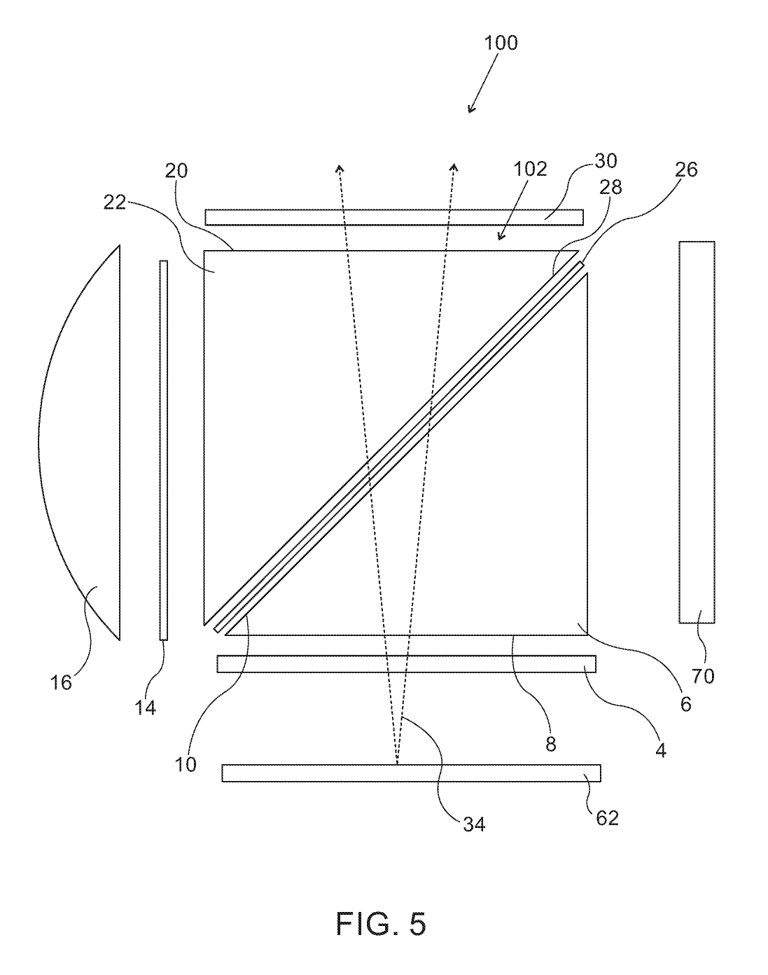

Use of the compound beam splitter configuration described above helps to further contribute to extinction of any undesired direct light from the light source 62 that might exit the optical device. This is shown in FIG. 5. The potential path of a beam of light waves is shown in dashed line in FIG. 5. Incident light waves 34 which can be from a LED, a laser or any other light source 62, passes through a linear polarizer 4 (linear polarizer 4 is optional in case the light-source itself is not polarized) as illustrated in FIG. 5. In order to reach the projector output, the light waves, which are linearly s-polarized relative to the plane of PBS configuration 10, and enter prism 102 through surface 8, would need to pass through PBS 24, through linear polarizer 26, through PBS 28, pass through external surface 20 of prism 22, and pass through linear polarizer 30. These light waves, which include skew rays, contain also undesired s-polarized light that is coming directly from the light source 62. The linear polarizer 26 helps to extinguish the power of these light waves in order to allow a high contrast ratio of the image information. For this purpose, the linear polarizer 26 has its polarization axis oriented at 90 degrees to that of linear polarizer 4. Any skew rays with p-polarized direct light from the light source that penetrate PBS 24 and 28 and polarizer 26, are attenuated by polarizer 30 that has its axis of polarization oriented parallel to linear polarizer 4.

The efficiency of extinction of light wave 34 according to various different implementations will be discussed in the following.

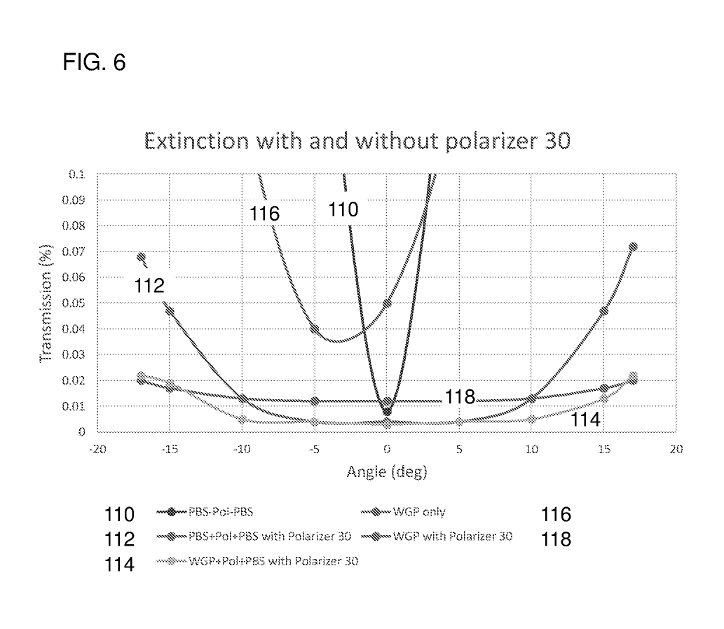

The extinction of two commercially-available linear polarizers when oriented at 90 degrees to each other, which is called cross polarizing position, can reach below 0.01% for incident light normal to the polarizing planes. However, when dealing with an inclined beam of light, say about ±17 degrees from normal incidence, the extinction may be different. Measuring the extinction of light beams with 17 degrees to the normal, in the plane of FIG. 4, shows that the extinction is almost the same as for normal incidence. When there is a component of the light beam inclination angle outside (perpendicular) to the plane of FIG. 4, the transmittance rises. This is shown by the graph in FIG. 6 for various different combinations of polarizer elements. All the curves are of polarized visible light passing through at least one linear polarizer or beam splitter forming various possible implementations of polarization-selective beam splitter configuration 10, in some cases followed by a second polarizer 30 at the outlet, and relate to the degree of extinction which is achieved. Curve 110 is the extinction function when the polarizer 26 is a linear polarizer in crossed orientation between dielectric coating PBS elements 24 and 28. Curve 116 is the extinction function when the polarization-selective beam splitter configuration 10 is implemented as a wire grid beam splitter used alone. Analyzing the transmitted beam for these two cases, without polarizer 30, shows that the beam has an s-polarization and also a p-polarization component with respect to the orientation of PBS configuration 10. The addition of linear polarizer 30 reduces the p-polarization component, as shown in curve 112 for the PBS-linear polarizer-PBS combination, and in curve 118 for the wire grid beam splitter used alone for beam splitter configuration 10. The addition of the linear polarizer 30 is thus seen to be highly advantageous for noise reduction and enhancing the contrast. The highest extinction over the entire angular range, shown by curve 114, was achieved when the beam splitter configuration 10 included a wire grid for PBS element 24, polarizer 26, and a dielectric PBS element 28, followed by polarizer 30 as part of the coupling-out arrangement.

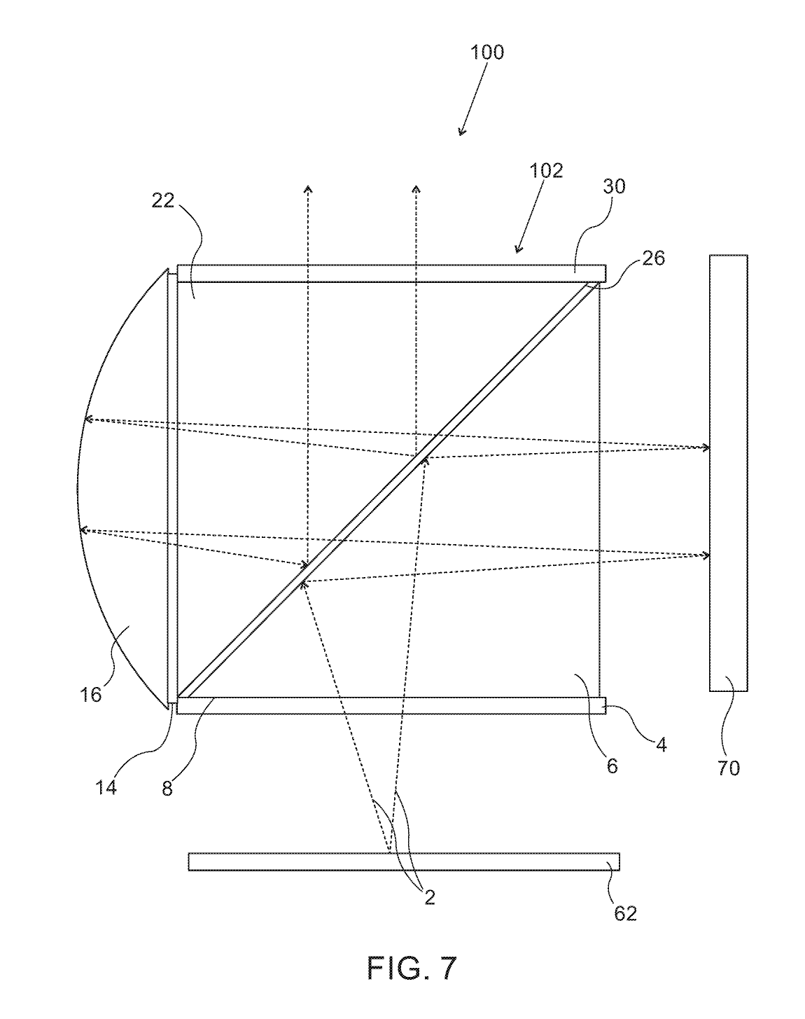

It is typically advantageous to attach some or all of the various components shown in FIG. 4 of the projector device to form a single compact element with a much simpler mechanical module. As already mentioned, prisms 6 and 22 are cemented together with PBS configuration 10. Depending on the details of the adjacent components in the overall optical design, it may be possible for some or all of the other polarizers 4 and 30, the reflecting and collimating element 16 and retarder(s) 14 to be cemented to the prisms. FIG. 7 illustrates such a module wherein all the elements except the LCOS 70 and the light source 62 are cemented. These elements are preferably mounted adjacent to the corresponding surfaces of the assembly, but not cemented thereto.

The device described thus far can be used in a wide range of applications for which a miniature projector generating a collimated image is needed. Examples of suitable applications include, but are not limited to, various imaging applications, such as head mounted displays (HMDs) and head-up displays (HUDs), cellular phones, compact displays, 3-D displays, compact beam expanders, as well as non-imaging applications, such as flat-panel indicators, compact illuminators and scanners. By way of illustration of one particularly preferred but non-limiting subset of applications, FIG. 8 illustrates a projector device 42 corresponding to the structure detailed with respect to FIG. 7, combined with a substrate 36 to form an optical system. Such a substrate 36 typically includes at least two major surfaces 32 and 34 and one or more partially reflecting surface 66 and an optical wedge element 38 for coupling light into the substrate. The output light-waves 40 from projector device 42 enter the substrate 36 through wedge 38. The incoming light-waves (vis-a-vis the substrate 36) are trapped in the substrate by Total Internal Reflection (TIR) as illustrated in FIG. 8. The outcoupling from the waveguide can be applied by partially reflecting surfaces 66 or by diffractive elements, or any other suitable outcoupling arrangement. The wedge element 38 is merely illustrative of one non-limiting optical coupling configuration, and other elements and configurations can be used to couple the light from the optical device into substrate 36.

The effect of the direct light beam from the light source to the optical substrate 36, as illustrated in FIG. 5, on the contrast (minimal contrast value of the system) of the image generated by the LCOS is given by:

$$contrast = \frac{Sw ( LCOS )}{Sb ( LCOS ) + Ndir + Nscat}$$

### Where,

Sw is the white image from the LCOS,
Sb is the black image from the LCOS,
Nscat is unwanted light entering substrate 36 as a result of scattering,
Ndir is the residual direct LED light, entering substrate 36.
Ndir is the unwanted noise that interferes with the image generated by the LCOS.

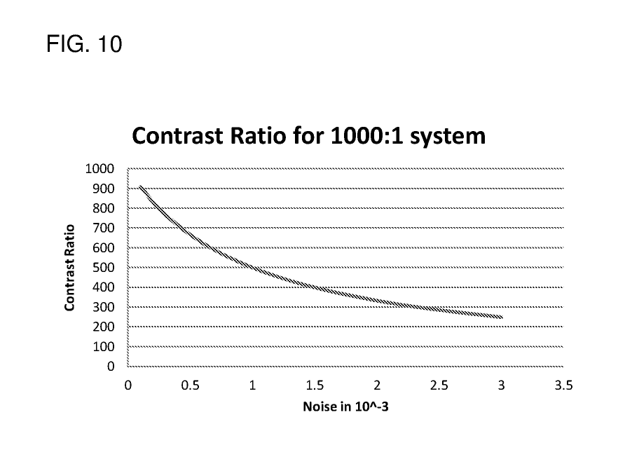

Assuming Nscat is very low, the effect of Ndir on the contrast is shown in FIG. 10. The contrast is limited by the extinction of the direct light beam (Ndir). Therefore, it is important to get maximal attenuation of this direct light beam, as proposed by the structures and optical configurations disclosed herein.

To the extent that the appended claims have been drafted without multiple dependencies, this has been done only to accommodate formal requirements in jurisdictions which do not allow such multiple dependencies. It should be noted that all possible combinations of features which would be implied by rendering the claims multiply dependent are explicitly envisaged and should be considered part of the invention.

It will be appreciated that the above descriptions are intended only to serve as examples, and that many other embodiments are possible within the scope of the present invention as defined in the appended claims.

What is claimed is:

1. An optical system, comprising:
(a) an image-collimating prism comprising a light-wave transmitting material, said prism having a plurality of external surfaces including a light-wave entrance surface and a light-wave exit surface, an image display surface and a collimation surface, a polarization-selective beam splitter configuration being deployed within said prism on a plane oblique to said light-wave entrance surface;
(b) a source of polarized light associated with said light-wave entrance surface;
(c) a reflective-display device associated with said image display surface of said prism, said reflective-display device generating spatial modulation of reflected light corresponding to an image, said reflective-display device being illuminated by light from said polarized source reflected from said beam splitter configuration, said reflective-display device being configured such that said reflected light corresponding to bright regions of said image has a polarization rotated relative to said source of polarized light;
(d) at least one retardation plate associated with at least part of said collimation surface; and
(e) at least one light-wave collimating component overlying at least part of said retardation plate,
such that an image from said reflective-display device is selectively transmitted by said polarization-selective beam splitter configuration, is collimated by said collimating component, reflected from said polarization-selective beam splitter configuration and is projected through said exit surface.

2. The optical system of claim 1, wherein said light-wave entrance surface and a light-wave exit surface of said prism are parallel.

3. The optical system of claim 1, wherein at least one angle between adjacent surfaces of said prism is non-orthogonal.

4. The optical system of claim 1, wherein said prism is a cuboid prism.

5. The optical system of claim 1, wherein said prism is a square cuboid prism.

6. The optical system of claim 1, wherein said polarization-selective beam splitter configuration is a wire grid beam splitter.

7. The optical system of claim 1, wherein said polarization-selective beam splitter configuration is a compound beam splitter configuration comprising:
(a) a first beam-splitter element closest to said source of polarized light;
(b) an absorptive polarizer; and
(c) a second beam-splitter element closest to said light-wave collimating component.

8. The optical system of claim 7, wherein said first beam-splitter element is a wire-grid beam splitter element.

9. The optical system of claim 7, further comprising an exit polarizer associated with said light-wave exit surface of said prism, said exit polarizer being oriented in crossed-relation to said absorptive polarizer so as to ensure extinction of any illumination from said source of polarized light that traverses said absorptive polarizer.

10. The optical system of claim 1, further comprising an exit polarizer associated with said light-wave exit surface of said prism, said exit polarizer being oriented in crossed-relation to said polarization-selective beam splitter configuration so as to ensure extinction of any illumination from said source of polarized light that traverses said polarization-selective beam splitter configuration.

11. The optical system of claim 1, wherein said reflective-display device comprises a liquid-crystal-on-silicon display.

12. The optical system of claim 1, further comprising a light-guiding substrate having at least two major surfaces parallel to each other, and a light-wave input aperture, wherein said light-wave input aperture is optically coupled to said light-wave exit surface of said prism.

13. The optical system of claim 12, wherein said light-transmitting substrate contains at least one partially-reflective surface extending within said substrate at an oblique angle to said major surfaces.

14. The optical system of claim 1, wherein said at least one retardation plate includes a first retardation plate having a fast axis aligned with an axis of polarization and a second retardation plate having a fast axis aligned at 45 degrees to an axis of polarization.
